(19) United States
(12) Patent Application Publication
(10) Pub. No.: US 2026/0141882 A1
(43) Pub. Date: May 21, 2026

(54) KEYBOARD DEVICE, ELECTRONIC PIANO AND CONNECTION METHOD FOR INTERNAL WALL

(71) Applicant: Roland Corporation, Shizuoka (JP)

(72) Inventor: Yukihide Takata, Shizuoka (JP)

(73) Assignee: Roland Corporation, Shizuoka (JP)

(21) Appl. No.: 19/389,075

(22) Filed: Nov. 14, 2025

(30) Foreign Application Priority Data
Nov. 21, 2024 (JP) 2024-203263

(51) Int. Cl. G10H 1/34

(52) U.S. Cl. CPC G10H 1/344; G10H 2220/221; G10H 2220/265

(57) ABSTRACT

A keyboard device of the disclosure includes: a white key made of resin, with a back end side swingably supported. The white key includes a narrow portion that constitutes a portion on the back end side of the white key, and a wide portion that is connected to a front end side of the narrow portion and has a larger dimension in a scale direction than the narrow portion. The wide portion includes a top wall with an upper surface serving as a key pressing surface, a pair of side walls that hang downward from both sides in the scale direction of the top wall, internal walls that are formed on a scale direction inner side with respect to the pair of side walls, and a front wall that is connected to the top wall and the side walls on a front side with respect to the internal walls. The internal walls each include a thickness reduction portion that is formed at a connection portion with the top wall or the side wall, and a thickness of the thickness reduction portion is thinner than a thickness of other portions of the internal wall.

### CROSS-REFERENCE TO RELATED APPLICATION

This application claims the priority benefit of Japanese application serial no. 2024-203263, filed on November 21, 2024. The entirety of the above-mentioned patent application is hereby incorporated by reference herein and made a part of this specification.

### Technical Field

The disclosure relates to a keyboard device, and particularly relates to a keyboard device and a connection method for internal wall that can improve the appearance of white keys.

### Background Art

For example, Patent Document 1 describes a technology for resin molding (injection molding) a white key 2a that includes a top wall 51 with the upper surface serving as a key pressing surface, and a pair of side walls 52 hanging downward from the end portions of the top wall 51 on both sides in the scale direction (left-right direction). In this technology, the pair of side walls 52 are connected by rib walls 55 extending in the scale direction, so that collapse of the side walls 52 during resin molding of the white key 2a can be regulated by the rib walls 55.

[Patent Document 1] Japanese Patent Application Laid-Open No. 2024-051204 (for example, paragraphs 0047, 0053, and FIG. 9)

However, the technology described above has a problem that the appearance of the white key 2a is easily impaired because sink marks during resin molding may occur at the connection portion between the top wall 51 and the rib walls 55, or at the connection portion between the side walls 52 and the rib walls 55.

The disclosure provides a keyboard device and a connection method for internal wall that can improve the appearance of white keys.

### SUMMARY

A keyboard device of the disclosure includes: a white key made of resin, with a back end side swingably supported. The white key includes a narrow portion that constitutes a portion on the back end side of the white key, and a wide portion that is connected to a front end side of the narrow portion and has a larger dimension in a scale direction than the narrow portion. The wide portion includes a top wall with an upper surface serving as a key pressing surface, a pair of side walls that hang downward from both sides in the scale direction of the top wall, internal walls that are formed on a scale direction inner side with respect to the pair of side walls, and a front wall that is connected to the top wall and the side walls on a front side with respect to the internal walls. The internal walls each include a thickness reduction portion that is formed at a connection portion with the top wall or the side wall, and a thickness of the thickness reduction portion is thinner than a thickness of other portions of the internal wall.

A connection method for internal wall of the disclosure is a connection method for internal wall in a keyboard device, including a white key made of resin with a back end side swingably supported. The white key includes a narrow portion that constitutes a portion on the back end side of the white key, and a wide portion that is connected to a front end side of the narrow portion and has a larger dimension in a scale direction than the narrow portion. The wide portion includes a top wall with an upper surface serving as a key pressing surface, a pair of side walls that hang downward from both sides in the scale direction of the top wall, internal walls that are formed on a scale direction inner side with respect to the pair of side walls, and a front wall that is connected to the top wall and the side walls on a front side with respect to the internal walls. The connection method for internal wall includes: forming on each of the internal walls a thickness reduction portion that is provided at a connection portion between the internal wall and the top wall or the side wall; and forming a thickness of the thickness reduction portion to be thinner than a thickness of other portions of the internal wall.

### BRIEF DESCRIPTION OF THE DRAWINGS

FIG. 1 is a cross-sectional view of the keyboard device in one embodiment.

FIG. 2 is a perspective view of the white key viewed from below.

FIG. 3A is a partially enlarged cross-sectional view of the keyboard device taken along line IIIa-IIIa in FIG. 1, FIG. 3B is a partially enlarged cross-sectional view of the keyboard device taken along line IIIb-IIIb in FIG. 1, and FIG. 3C is a partially enlarged cross-sectional view of the keyboard device taken along line IIIc-IIIc in FIG. 3A.

FIG. 4A is a partially enlarged cross-sectional view of the keyboard device taken along line IVa-IVa in FIG. 3C, FIG. 4B is a partially enlarged cross-sectional view of the keyboard device taken along line IVb-IVb in FIG. 3C, and FIG. 4C is a partially enlarged cross-sectional view of the keyboard device taken along line IVc-IVc in FIG. 3C.

### DESCRIPTION OF THE EMBODIMENTS

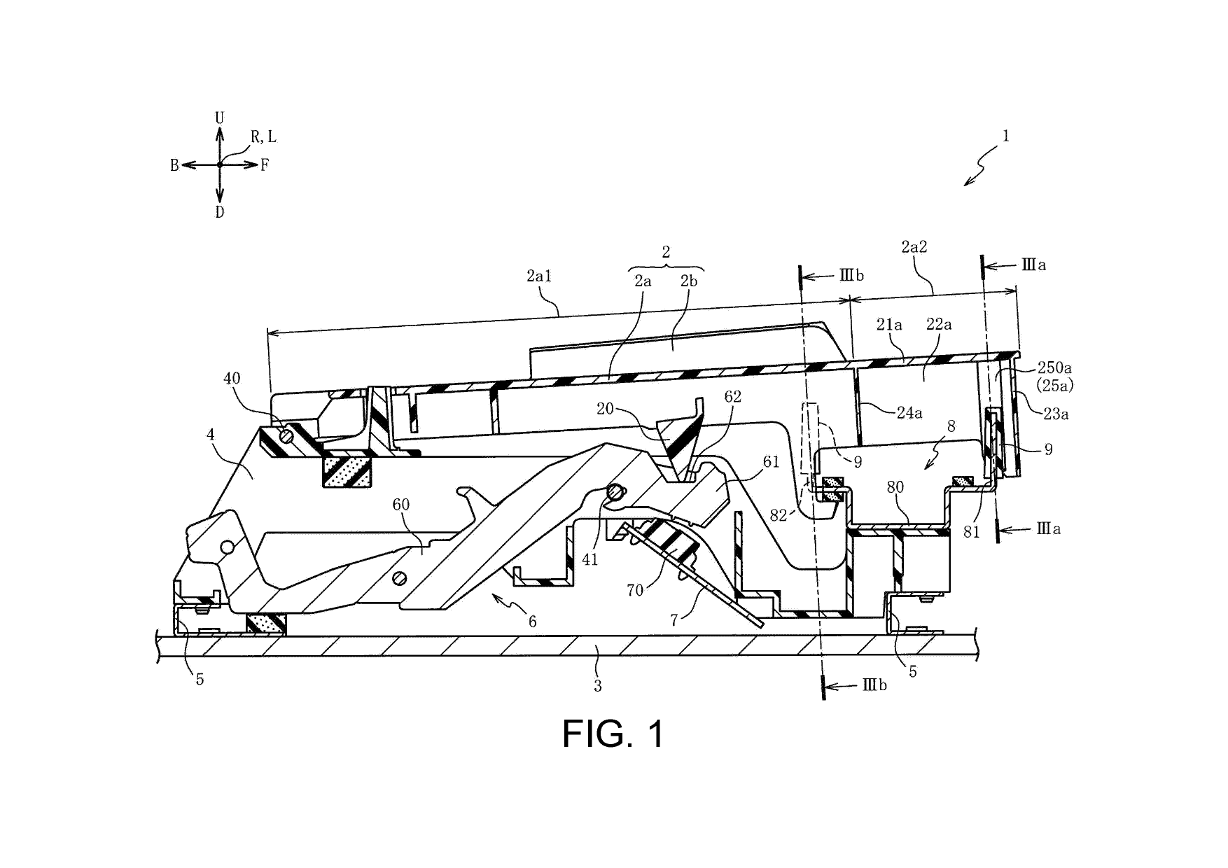

Hereinafter, exemplary embodiments will be described with reference to the accompanying drawings. First, the overall configuration of a keyboard device 1 will be described with reference to FIG. 1. FIG. 1 is a cross-sectional view of the keyboard device 1 in one embodiment. FIG. 1 illustrates a guide portion 82 (guide component 9) of a black key 2b hidden behind a white key 2a with a broken line.

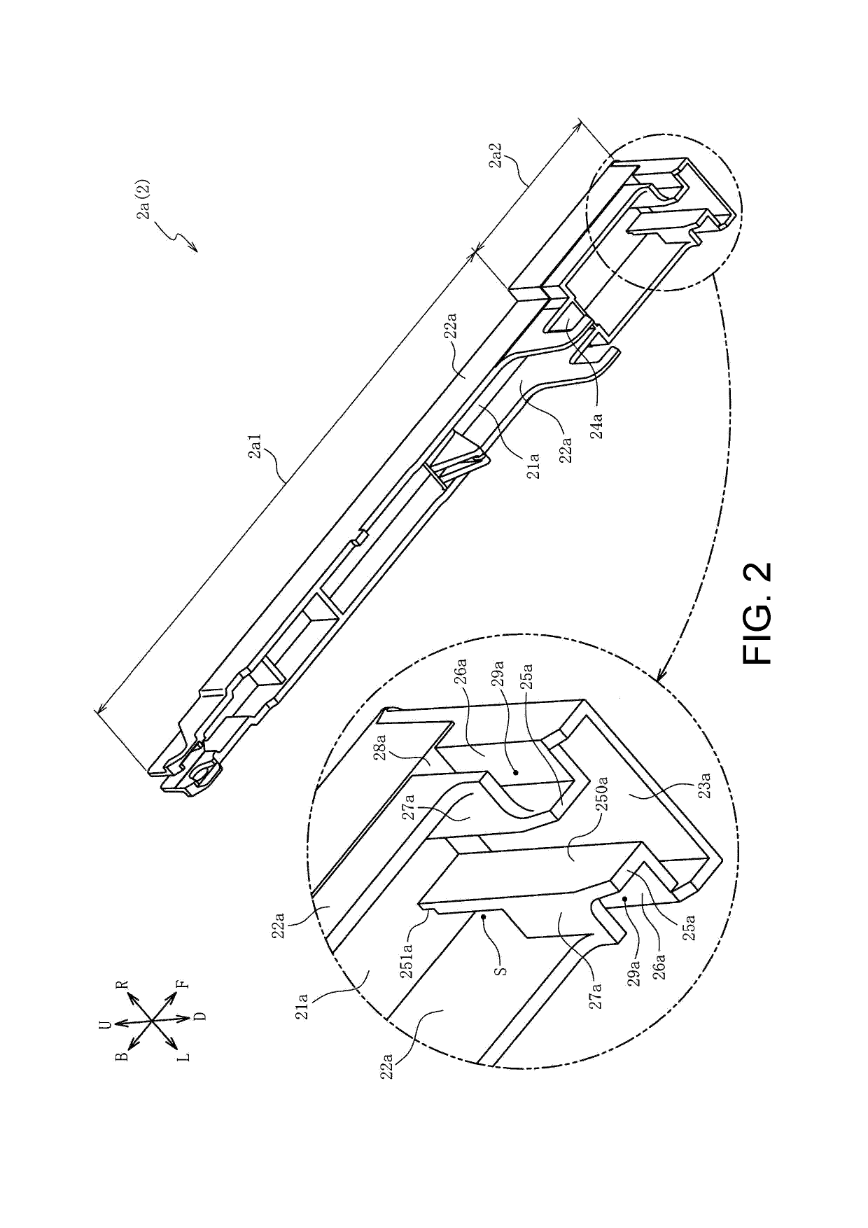

Further, the directions of arrows U-D, F-B, and L-R in FIG. 1 respectively indicate an up-down direction, a front-back direction, and a left-right direction (an arrangement direction of multiple keys 2, hereinafter referred to as "scale direction") of the keyboard device 1, and the same applies to FIG. 2 and subsequent drawings. FIG. 1 is a cross-sectional view of the keyboard device 1 cut along a plane orthogonal to the scale direction.

As shown in FIG. 1, the keyboard device 1 includes multiple (88 in the present embodiment) keys 2 formed using a resin material, and is a device that constitutes a keyboard instrument (an electronic piano or synthesizer). The keys 2 include multiple (52 in the present embodiment) white keys 2a for playing natural tones and multiple (36 in the present embodiment) black keys 2b for playing derived sounds, and the multiple white keys 2a and black keys 2b are arranged in the scale direction (direction of arrow L-R). Hereinafter, the white keys 2a and the black keys 2b will be described as keys 2 in the case of not being distinguished from each other.

The keyboard device 1 includes a shelf board 3 for supporting the keys 2, and the shelf board 3 is formed in a flat plate shape extending in the scale direction using synthetic resin, steel plate, or the like. A chassis 4 made of resin is supported on the upper surface of the shelf board 3. The chassis 4 has both front and back end portions (direction of arrow F-B) fixed to the shelf board 3 via channel members 5, and a rotation shaft 40 extending along the scale direction is provided on the upper surface of the back end side (side of arrow B) of the chassis 4. The back end portion of the key 2 is rotatably (swingably) supported by the rotation shaft 40, and a hammer 6 that interlocks with the rotation of the key 2 is provided below the key 2.

A rotation shaft 41 extending along the scale direction is provided at a substantially central portion in the front-back direction of the chassis 4, and the hammer 6 is rotatably supported by this rotation shaft 41. The hammer 6 includes a mass portion 60 (mass body) positioned on the back side (side of arrow B) with respect to the rotation shaft 41, and a pressing portion 61 positioned on the front side (side of arrow F) with respect to the rotation shaft 41.

A receiving portion 62 that is recessed downward is formed on the upper surface of the pressing portion 61, and a protrusion portion 20 that protrudes downward from the lower surface of the key 2 is inserted into the receiving portion 62. During pressing of the key 2, the tip of the protrusion portion 20 slides on the bottom surface of the receiving portion 62, causing the hammer 6 to rotate around the rotation shaft 41, and the mass portion 60 is lifted by this rotation of the hammer 6. The reaction force accompanying this rotation of the hammer 6 provides the player a key pressing sensation during pressing of the key 2.

Additionally, a substrate 7 having a switch 70 on the upper surface is provided below the pressing portion 61, and during pressing of the key 2, the switch 70 is pushed by the pressing portion 61 that displaces downward. Key pressing information (note information) of the key 2 is detected by on/off of this switch 70, and a musical sound signal based on the detection result is output to the outside.

In the case of the key 2 being released after key pressing, the key 2 (hammer 6) rotates in an operation opposite to the above-described key pressing, and the rotation of the key 2 during these key pressing and key releasing is guided by a guide member 8. The guide member 8 is a member made of metal and attached to the upper surface on the front end side (side of arrow F) of the chassis 4.

The guide member 8 includes a fixed portion 80 fixed to the chassis 4, and guide portions 81 and 82 that rise upward from both front and back end portions of the fixed portion 80. These portions 80 to 82 are integrally formed by bending a metal plate. A guide component 9 made of rubber or elastomer that is softer (has lower hardness) than the key 2 is attached to each of the guide portions 81 and 82.

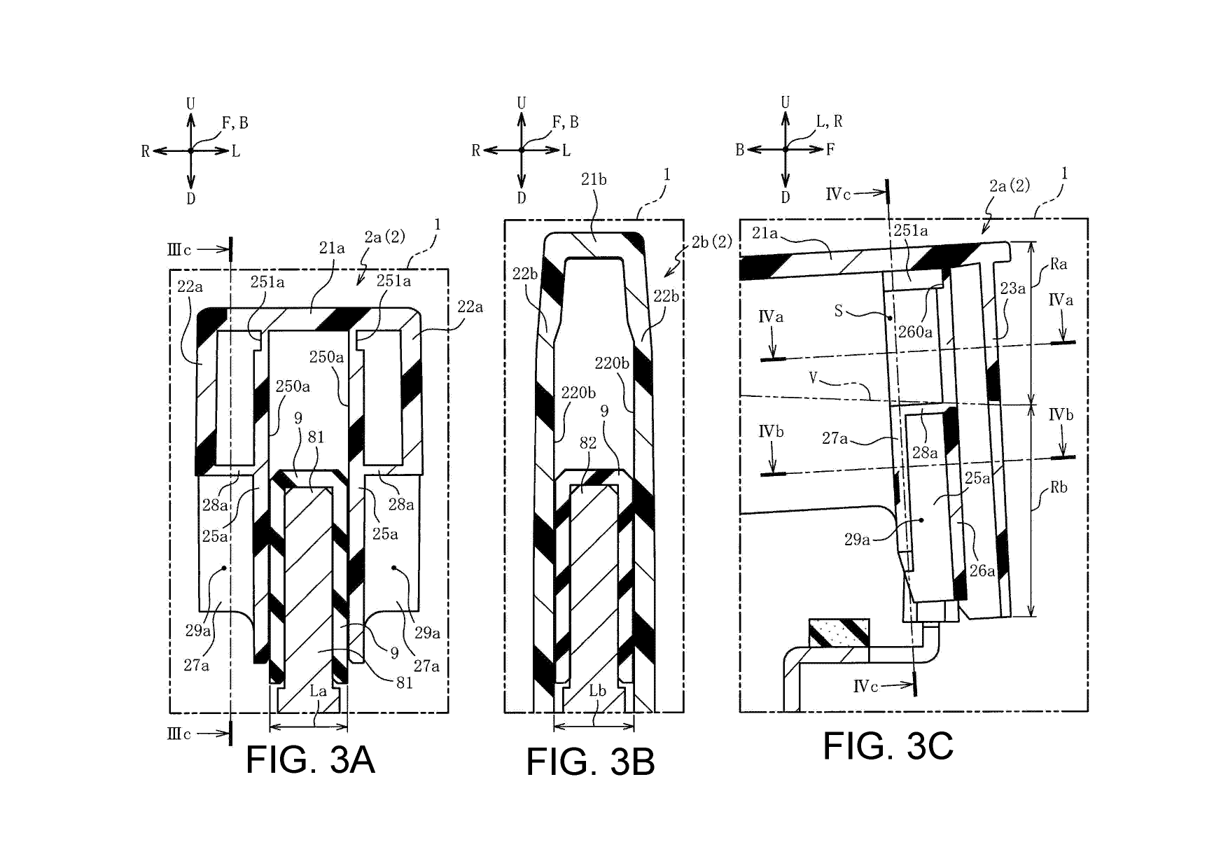

The guide component 9 is formed in a cylindrical shape having an insertion hole 90 (see FIG. 3A or FIG. 3B) that extends upward from the lower surface, and the guide portions 81 and 82 are inserted into this insertion hole 90. The rotation of the white key 2a is guided by the guide portion 81 positioned on the front end side (side of arrow F) of the guide member 8, and the rotation of the black key 2b is guided by the guide portion 82 positioned on the back side (side of arrow B) with respect to the guide portion 81.

Next, the configuration of the guide portion of the white key 2a formed by the guide portion 81 (guide component 9) will be described with reference to FIG. 1 and FIG. 2. FIG. 2 is a perspective view of the white key 2a viewed from below.

As shown in FIG. 1 and FIG. 2, the white key 2a includes a narrow portion 2a1 that constitutes a portion on the back end side (side of arrow B), and a wide portion 2a2 that is connected to the front end side (the end portion on the side of arrow F) of the narrow portion 2a1 and has a larger width dimension in the scale direction (direction of arrow L-R) than the narrow portion 2a1. The narrow portion 2a1 is a portion that adjoins the black key 2b (see FIG. 1) in the scale direction, and the wide portion 2a2 is a portion positioned on the front side with respect to the black key 2b. These narrow portion 2a1 and wide portion 2a2 are integrally molded using a resin material from the plate-shaped walls 21a to 28a described below.

Each of the narrow portion 2a1 and the wide portion 2a2 includes a top wall 21a that has an upper surface serving as a key pressing surface, and a pair of side walls 22a that hang downward from both end portions in the scale direction of the top wall 21a, so as to be formed in a box shape having an opening on the lower surface side. The front end side of the space surrounded by the top wall 21a and the side walls 22a is closed by a front wall 23a, and the boundary portion between the narrow portion 2a1 and the wide portion 2a2 in the same space is partitioned by a partition wall 24a.

Guide walls 25a (see the enlarged portion in FIG. 2) for guiding the rotation of the white key 2a are formed on the scale direction inner side with respect to the pair of side walls 22a of the wide portion 2a2 (inside the wide portion 2a2), and the guide walls 25a are provided as a pair with an interval in the scale direction. The side surfaces on the scale direction inner side of the pair of guide walls 25a (the surfaces where the pair of guide walls 25a face each other) are guide surfaces 250a that are guided by the guide portion 81, and the guide portion 81 (guide component 9) is inserted between this pair of guide surfaces 250a.

Next, the detailed configuration of the guide portions of the white key 2a and the black key 2b will be described with reference to FIG. 2 and FIG. 3A to FIG. 3C. FIG. 3A is a partially enlarged cross-sectional view of the keyboard device 1 taken along line IIIa-IIIa in FIG. 1, FIG. 3B is a partially enlarged cross-sectional view of the keyboard device 1 taken along line IIIb-IIIb in FIG. 1, and FIG. 3C is a partially enlarged cross-sectional view of the keyboard device taken along line IIIc-IIIc in FIG. 3A. FIG. 3A to FIG. 3C show only the main parts of the keyboard device 1.

As shown in FIG. 2 and FIG. 3A to FIG. 3C, similar to the white key 2a, the black key 2b (see FIG. 3B) includes a top wall 21b that has an upper surface serving as a key pressing surface, and a pair of side walls 22b that hang downward from both end portions in the scale direction (direction of arrow L-R) of the top wall 21b, so as to be formed in a box shape having an opening on the lower surface side. The side surfaces on the scale direction inner side of the pair of side walls 22b are guide surfaces 220b that are guided by the guide portion 82, and the guide portion 82 (guide component 9) is inserted between this pair of guide surfaces 220b.

An interval La (see FIG. 3A) in the scale direction between the pair of guide walls 25a (guide surfaces 250a) of the white key 2a is the same as an interval Lb (see FIG. 3B) between the pair of side walls 22b (guide surfaces 220b) of the black key 2b. That is, since the interval La between the guide walls 25a of the white key 2a (the guide width of the white key 2a) is narrower than the interval between the pair of side walls 22a, the guide portion 81 and the guide component 9 mounted on the guide portion 81 can be made smaller compared to, for example, a case where the side walls 22a are used to guide the rotation of the white key 2a (inserting a portion corresponding to the guide portion 81 between the pair of side walls 22a). Therefore, the manufacturing cost of the keyboard device 1 can be reduced.

Moreover, since the guide width La of the white key 2a and the guide width Lb of the black key 2b are the same, common guide components 9 can be mounted on the guide portions 81 and 82 that guide these keys 2. This can reduce the number of parts, so the manufacturing cost of the keyboard device 1 can be reduced.

The upper end of each of the pair of guide walls 25a is connected to the top wall 21a, and at this connection portion (a region including the upper end of the guide wall 25a), a thickness reduction portion 251a (see the enlarged portion in FIG. 2 or FIG. 3A) is formed by recessing the side surface of the guide wall 25a into a rectangular cross section. The thickness reduction portion 251a is formed in a groove shape extending along the front-back direction (the direction of connection with the top wall 21a).

The thickness of the guide wall 25a (internal wall) in the region where the thickness reduction portion 251a is formed is formed thinner than the thickness of the guide wall 25a positioned below the thickness reduction portion 251a (other portions of the guide wall 25a other than the thickness reduction portion 251a) and the thickness of the top wall 21a. This can suppress occurrence of sink marks at the connection portion between the top wall 21a and the guide wall 25a during molding of the resin white key 2a, so the appearance of the white key 2a can be improved.

Moreover, a first rib wall 26a and a second rib wall 27a (see the enlarged portion in FIG. 2) extending from the side wall 22a toward the scale direction inner side are connected to the guide wall 25a (hereinafter, the first rib wall 26a and the second rib wall 27a are collectively referred to as "rib walls 26a and 27a"). The first rib wall 26a connects the front end of the guide wall 25a and the side wall 22a in the scale direction, and the second rib wall 27a connects the back end of the guide wall 25a and the side wall 22a in the scale direction. By connecting the side wall 22a and the guide wall 25a with the rib walls 26a and 27a, the rigidity of the guide wall 25a can be improved, so the rotation of the white key 2a can be stably guided by sliding between the guide surface 250a and the guide portion 81 (guide component 9).

In other words, by connecting the guide wall 25a and the side wall 22a with the rib walls 26a and 27a, the load in the scale direction that acts during sliding between the guide surface 250a and the guide portion 81 (guide component 9) can be mainly received by the rib walls 26a and 27a. Therefore, concentration of a similar load on the thickness reduction portion 251a can be suppressed accordingly, so the thickness of the thickness reduction portion 251a can be reduced. By reducing the thickness of the thickness reduction portion 251a, occurrence of sink marks at the connection portion between the top wall 21a and the guide wall 25a can be effectively suppressed.

In addition, the thickness reduction portion 251a is formed on the side surface facing the scale direction outer side (on the side opposite to the guide surface 250a) of the guide wall 25a.

That is, since the thickness reduction portion 251a is not formed in the sliding region of the guide portion 81 (guide component 9) along the guide surface 250a, the guide portion 81 can be slid along the planar guide surface 250a throughout the entire sliding region. Therefore, the rotation of the white key 2a can be stably guided by sliding between the guide surface 250a and the guide portion 81 (guide component 9).

Here, in the present embodiment, the front end of the guide wall 25a is connected to the first rib wall 26a, but it is also possible to connect the guide wall 25a extending to the front side (side of arrow F) from this connection portion to the front wall 23a, for example. While the rigidity of the guide wall 25a can be improved by the front wall 23a with such a configuration, sink marks during resin molding are likely to occur at the connection portion between the guide wall 25a and the front wall 23a.

In contrast thereto, in the present embodiment, the front end of the guide wall 25a is not connected to the front wall 23a (a gap is formed between these walls 23a and 25a) (see the enlarged portion in FIG. 2). With such a configuration, sink marks can be reliably prevented from occurring on the front wall 23a during resin molding of the white key 2a, so the appearance of the white key 2a can be improved. Moreover, even in the configuration having a gap formed between the guide wall 25a and the front wall 23a, both front and back ends of the guide wall 25a are connected to the side wall 22a via the rib walls 26a and 27a, so the rigidity of the guide wall 25a can be secured by the rib walls 26a and 27a.

Similar to the guide wall 25a, the upper end of the first rib wall 26a is connected to the top wall 21a (see FIG. 3C), while a gap S is formed between the second rib wall 27a and the top wall 21a. This gap S allows a slide core to pass through during mold forming of the white key 2a, and details of the mold forming of the white key 2a will be described later.

A partition wall 28a (see the enlarged portion in FIG. 2 or FIG. 3C) is connected to the upper end of the second rib wall 27a, and this partition wall 28a is a wall that closes the upper portion of a recess 29a formed on the side surface of the side wall 22a (wide portion 2a2). The recess 29a is a recess surrounded by the guide wall 25a and the rib walls 26a and 27a (with the guide wall 25a as the bottom surface). The partition wall 28a that closes the upper end of this recess 29a connects the upper end of the second rib wall 27a and the substantial center in the up-down direction of the first rib wall 26a in the front-back direction (see FIG. 3C), and connects the substantially central portion in the up-down direction of the guide wall 25a and the side wall 22a in the scale direction (see FIG. 3A).

By forming such a partition wall 28a, the rigidity of the guide wall 25a can be secured by the rib walls 26a and 27a and the partition wall 28a even with the gap S formed between the second rib wall 27a and the top wall 21a. Therefore, the rotation of the white key 2a can be stably guided by sliding between the guide surface 250a and the guide portion 81 (guide component 9).

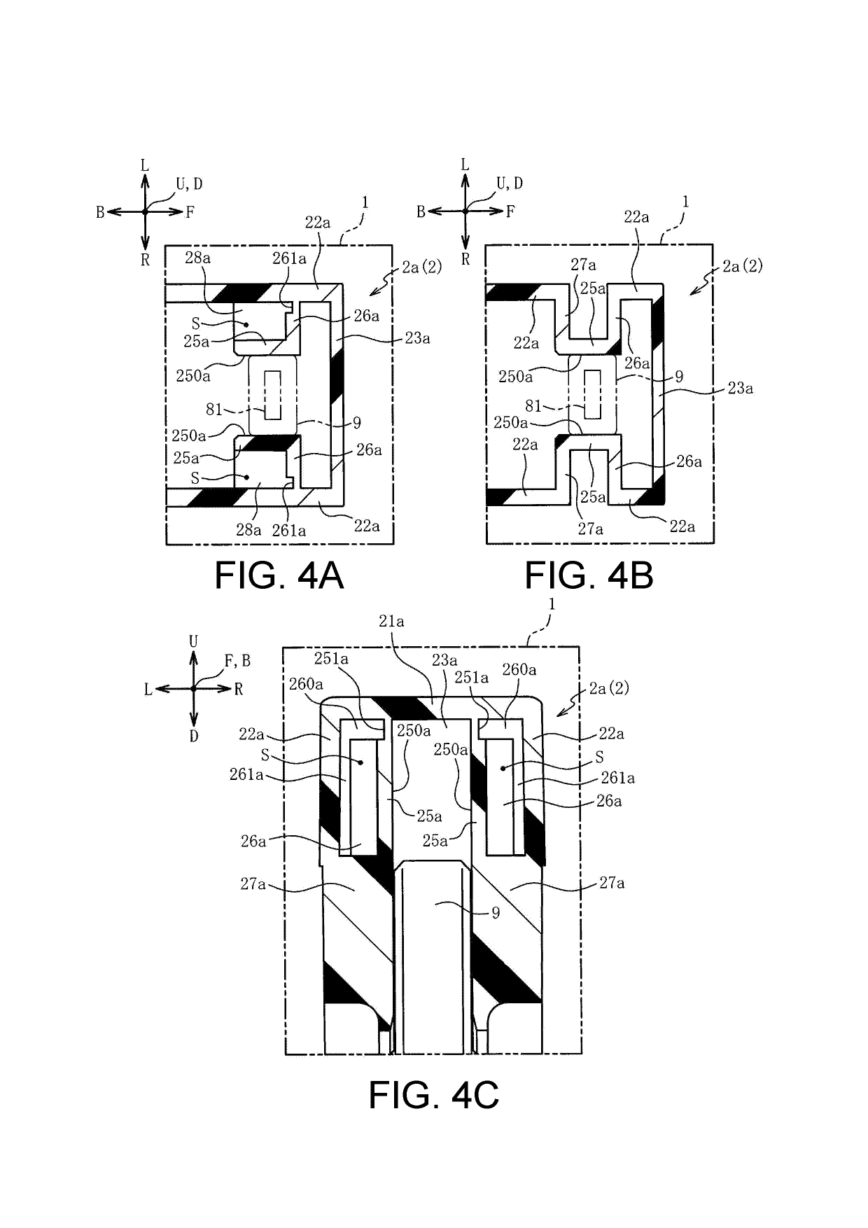

Next, the configuration of the guide portion of the white key 2a will be further described with reference to FIG. 3A to FIG. 3C and FIG. 4A to FIG. 4C. FIG. 4A is a partially enlarged cross-sectional view of the keyboard device 1 taken along line IVa-IVa in FIG. 3C, FIG. 4B is a partially enlarged cross-sectional view of the keyboard device 1 taken along line IVb-IVb in FIG. 3C, and FIG. 4C is a partially enlarged cross-sectional view of the keyboard device 1 taken along line IVc-IVc in FIG. 3C. In FIG. 4A and FIG. 4B, the outlines of the guide portion 81 and the guide component 9 are schematically illustrated with two-dot chain lines to simplify the drawings.

As shown in FIG. 3A to FIG. 3C and FIG. 4A to FIG. 4C, a thickness reduction portion 260a (see FIG. 3C or FIG. 4C) is formed at the connection portion between the first rib wall 26a and the top wall 21a, and a thickness reduction portion 261a (see FIG. 4A or FIG. 4C) is formed at the connection portion between the first rib wall 26a and the side wall 22a. These thickness reduction portions 260a and 261a are recesses with rectangular cross section formed on the back surface (the surface facing the side of arrow B) of the first rib wall 26a. The thickness reduction portion 260a is formed in a groove shape extending along the scale direction (direction of arrow L-R) (see FIG. 4C), and the thickness reduction portion 261a is formed in a groove shape extending along the up-down direction (see FIG. 4C).

The end portion on the scale direction inner side of the thickness reduction portion 260a is connected to the front end of the thickness reduction portion 251a of the guide wall 25a (see FIG. 3C and FIG. 4C). Further, the end portion on the scale direction outer side of the thickness reduction portion 260a is connected to the upper end of the thickness reduction portion 261a (see FIG. 4C).

The thickness of the first rib wall 26a (internal wall) in the region where the thickness reduction portions 260a and 261a are formed is formed thinner than the thickness of portions of the first rib wall 26a other than the thickness reduction portion 260a, and the thicknesses of the top wall 21a and the side wall 22a. This can suppress occurrence of sink marks at the connection portion between the top wall 21a and the first rib wall 26a, and at the connection portion between the side wall 22a and the first rib wall 26a during resin molding of the white key 2a, so the appearance of the white key 2a can be improved.

Here, in FIG. 3C, the key pressing surface (the upper surface of the top wall 21a) in the case of the white key 2a being displaced to a terminal position of key pressing is indicated by a virtual line V. In the case of another white key (not shown) adjacent to the white key 2a being pressed, the upper side of the virtual line V becomes a visible region Ra where the side surface (side wall 22a) of the white key 2a is exposed (becomes visible from outside), while the lower side of the virtual line V becomes an invisible region Rb where the side surface of the white key 2a is hidden by the other white key that has been pressed.

In the case of the white key 2a being displaced from an initial position before key pressing to the terminal position, the guide portion 81 (guide component 9) constantly slides against the guide surface 250a of the guide wall 25a positioned in the invisible region Rb. Therefore, it is preferable to increase the rigidity of the guide wall 25a in the invisible region Rb. Furthermore, while securing the appearance of the white key 2a is required in the visible region Ra, sink marks occurring on the side surface (side wall 22a) of the white key 2a in the invisible region Rb do not particularly cause a problem.

Thus, in the present embodiment, the first rib wall 26a positioned in the visible region Ra adopts a configuration where the thickness reduction portion 261a is formed at the connection portion with the side wall 22a (see FIG. 4A), while the first rib wall 26a positioned in the invisible region Rb adopts a configuration where no thickness reduction portion is formed at the connection portion with the side wall 22a (see FIG. 4B).

Accordingly, in the visible region Ra, sink marks during resin molding can be suppressed from occurring on the side surface of the white key 2a (side wall 22a), while in the invisible region Rb, the rigidity of the guide wall 25a can be effectively improved by the first rib wall 26a. Therefore, it is possible to stably guide the rotation of the white key 2a by sliding between the guide surface 250a and the guide portion 81 (guide component 9) while improving the appearance of the white key 2a.

In addition, the lower surface of the partition wall 28a (the upper end of the recess 29a) is positioned below the virtual line V (see FIG. 3C), and the entire recess 29a is formed in the invisible region Rb. Accordingly, the recess 29a can be suppressed from being exposed in the visible region Ra during pressing of another white key (not shown), so the appearance of the white key 2a can be improved.

Here, for example, in the case of resin molding the white key 2a with a mold composed of an upper mold and a lower mold, the demolding direction is mainly the up-down direction of the white key 2a, and the thickness reduction portion 251a of the guide wall 25a and the thickness reduction portions 260a and 261a of the first rib wall 26a become undercuts with respect to this demolding direction. Therefore, in the present embodiment, each of the thickness reduction portions 251a, 260a, and 261a is formed by a slide core that slides (in the front-back direction) through the gap S between the top wall 21a and the second rib wall 27a.

In the case of using such a slide core, for a configuration that forms the thickness reduction portion 251a on the guide surface 250a side of the guide wall 25a, it is required to also form the guide surface 250a by the slide core. For example, in a configuration where a part of the upper end side of the guide surface 250a is formed by the slide core (the portion on the lower end side of the guide surface 250a is formed by the lower mold), defects such as burrs extending in the front-back direction are easily formed on the guide surface 250a due to the parting line between the slide core and the lower mold.

Further, even in a configuration where the entire guide surface 250a is formed by the slide core, similar defects are easily formed at the lower end of the guide surface 250a. Furthermore, in a configuration where the guide surface 250a is formed by a slide core that slides in the front-back direction, errors are likely to occur in the width dimension (or formation position) of the guide surface 250a in the same direction.

In contrast thereto, the thickness reduction portion 251a of the present embodiment is formed on the side surface opposite to the guide surface 250a of the guide wall 25a, which can eliminate the need for forming the guide surface 250a by a slide core (the guide surface 250a can be formed by the lower mold). Accordingly, it is possible to suppress defects such as burrs from occurring on the guide surface 250a, and to suppress errors from occurring in the width dimension of the guide surface 250a in the front-back direction, so the guide surface 250a can be formed with high accuracy.

Additionally, for the purpose of providing the thickness reduction portion 260a at the connection portion between the top wall 21a and the first rib wall 26a, for example, it is also possible to adopt a configuration where the thickness reduction portion 260a is provided on the front surface side of the first rib wall 26a (the surface facing the front wall 23a), and the thickness reduction portion 260a is formed by a slide core that slides in the front-back direction between the first rib wall 26a and the front wall 23a. However, for such a configuration, it is required to secure a space for sliding the slide core between the first rib wall 26a and the front wall 23a (to form a wide gap between these walls 23a and 26a), so accordingly, it is required to form the first rib wall 26a and the guide wall 25a on the back side (side of arrow B in FIG. 3C).

In contrast thereto, in the present embodiment, the thickness reduction portion 260a is formed on the back surface of the first rib wall 26a, so the thickness reduction portion 260a can be formed by a slide core that slides on the back side of the first rib wall 26a. Therefore, the first rib wall 26a and the guide wall 25a can be formed on the front side (side of arrow F in FIG. 3C) compared to a case where the thickness reduction portion 260a is formed on the front surface of the first rib wall 26a. By forming the guide wall 25a as far forward as possible on the white key 2a, that is, at a position away from the rotation shaft 40 (see FIG. 1) of the white key 2a, the rotation of the white key 2a can be stably guided by sliding between the guide portion 81 (guide component 9) and the guide surface 250a.

Further, in the present embodiment, the gap S is formed between the top wall 21a and the second rib wall 27a, but it is also possible to adopt a configuration where the gap S is closed by connecting the second rib wall 27a to the top wall 21a, and the partition wall 28a is omitted (hereinafter simply referred to as "configuration that closes the gap S"). In the case of such a configuration that closes the gap S, the thickness reduction portions 260a and 261a of the first rib wall 26a can be formed by using a slide core that slides in the front-back direction between the rib walls 26a and 27a.

However, for the configuration that closes the gap S, it is required to secure a wide front-back interval between the rib walls 26a and 27a in order to secure a space for sliding the slide core. Widening the interval between the rib walls 26a and 27a may impair the rigidity of the guide wall 25a.

In addition, in the configuration that closes the gap S, the slide direction (scale direction) of the slide core that forms the thickness reduction portion 251a of the guide wall 25a and the slide direction (front-back direction) of the slide core that forms the thickness reduction portions 260a and 261a of the first rib wall 26a become different directions. Therefore, there is a problem that it becomes difficult to form the thickness reduction portions 251a, 260a, and 261a.

To solve this problem, it is conceivable to form the thickness reduction portion 251a of the guide wall 25a on the guide surface 250a side (the surface facing the back side in the direction perpendicular to the paper surface of FIG. 3C), but in this configuration, it is required to form the thickness reduction portion 251a of the guide wall 25a and the thickness reduction portions 260a and 261a of the first rib wall 26a with separate slide cores, which complicates the structure of the mold.

In contrast thereto, in the present embodiment, the gap S is formed between the top wall 21a and the second rib wall 27a, and this gap S is formed in a range that overlaps with the entirety of the thickness reduction portions 260a and 261a of the first rib wall 26a in the front-back direction view (see FIG. 4C). Accordingly, the thickness reduction portions 260a and 261a of the first rib wall 26a can be formed by a slide core that slides in the front-back direction through the gap S. Thus, unlike the configuration that closes the gap S as described above, it is not required to provide a space for sliding the slide core between the rib walls 26a and 27a. Since the interval between the rib walls 26a and 27a can be narrowed, the rigidity of the guide wall 25a can be effectively improved by the rib walls 26a and 27a.

Furthermore, unlike the configuration that closes the gap S as described above, the configuration that forms the thickness reduction portions 260a and 261a of the first rib wall 26a by a slide core through the gap S can make the demolding direction of the thickness reduction portion 251a of the guide wall 25a and the demolding direction of the thickness reduction portions 260a and 261a of the first rib wall 26a match each other. Accordingly, for example, the thickness reduction portions 251a, 260a, and 261a can be formed by a common slide core, so the structure of the mold can be simplified.

Further, the gap S between the top wall 21a and the second rib wall 27a is formed to a position where the lower end thereof reaches the invisible region Rb, and the second rib wall 27a is formed entirely in the invisible region Rb. As described above, in the invisible region Rb, the rigidity of the guide wall 25a is prioritized over the appearance of the white key 2a, so in the present embodiment, no thickness reduction portion is formed at the connection portion between the second rib wall 27a and the side wall 22a (see FIG. 4B). Accordingly, it is possible to effectively increase the rigidity of the guide wall 25a by the second rib wall 27a while suppressing deterioration of the appearance of the white key 2a.

Although the present embodiment adopts a configuration where no thickness reduction portion is formed in the entire second rib wall 27a positioned in the invisible region Rb, a thickness reduction portion may be formed at the connection portion with the side wall 22a for a part of or the entire second rib wall 27a. Further, for the portion of the above-described first rib wall 26a positioned in the invisible region Rb, a thickness reduction portion may be similarly formed at the connection portion with the side wall 22a for a part of or the entire first rib wall 26a.

Although the disclosure has been described based on the above embodiments, the disclosure is not limited to the above embodiments in any way, and it can be easily inferred that various improvements and modifications are possible within the scope that does not depart from the spirit of the disclosure.

Although description is omitted from the above embodiments, the thickness of the thickness reduction portions 251a, 260a, and 261a of the guide wall 25a and the first rib wall 26a is preferably 1/2 or more and 2/3 or less of the thickness of the wall to be connected (in the case of the thickness reduction portion 251a, the top wall 21a), for example. Accordingly, sink marks can be suppressed from occurring on the wall to which the thickness reduction portions 251a, 260a, and 261a are connected.

Although the above embodiments illustrate the guide wall 25a and the first rib wall 26a as examples of the internal wall (the wall formed on the scale direction inner side with respect to the side wall 22a) in which the thickness reduction portions 251a, 260a, and 261a are formed, the disclosure is not necessarily limited thereto. For example, the thickness reduction portion may be formed at the connection portions between the partition wall 24a and the top wall 21a and side wall 22a, or at the connection portions between the second rib wall 27a and partition wall 28a and the side wall 22a. Further, in the case of the upper end of the second rib wall 27a being connected to the top wall 21a, the thickness reduction portion may be formed at the connection portion.

Furthermore, in the case of internal walls other than the walls 24a to 28a described in the above embodiments being formed on the scale direction inner side with respect to the side wall 22a, the thickness reduction portion may be formed at the connection portions between the other internal walls and the top wall 21a and side wall 22a. In the case of forming the thickness reduction portion in such other internal walls, the thickness reduction portions 251a, 260a, and 261a of the guide wall 25a and first rib wall 26a may be omitted.

In addition, the thickness reduction portion is preferably formed over the entire connection portion with the wall to be connected (for example, from the front end to the back end in the case of the guide wall 25a), but the thickness reduction portion may not be formed in a part of the region in the connection portion.

Although the above embodiments illustrate a configuration where the end portions of the guide wall 25a and the first rib wall 26a are recessed in a rectangular shape as examples of the thickness reduction portions 251a, 260a, and 261a, the disclosure is not necessarily limited thereto. For example, the cross-sectional shape of the thickness reduction portions 251a, 260a, and 261a may be formed in a shape other than a rectangular shape. Further, in the case of a configuration where the thickness of the internal wall (for example, the guide wall 25a) is formed to gradually become thinner as it approaches the wall to be connected (for example, the top wall 21a), the tapered portion corresponds to the thickness reduction portion.

Although the above embodiments illustrate a case where both front and back end portions of the guide wall 25a are connected to the side walls 22a by the rib walls 26a and 27a, the disclosure is not necessarily limited thereto. For example, either one or both of the rib walls 26a and 27a may be omitted, or other walls may be connected to the guide wall 25a in addition to the rib walls 26a and 27a.

Although the above embodiments illustrate a case where the thickness reduction portion 251a is formed on the side surface facing the scale direction outer side (on the opposite side from the guide surface 250a) of the guide wall 25a, the disclosure is not necessarily limited thereto.

For example, the thickness reduction portion 251a may be formed only on the guide surface 250a, or the thickness reduction portion 251a may be formed on both the guide surface 250a and the side surface on the opposite side from the guide surface. Regarding the first rib wall 26a, similarly, the thickness reduction portions 260a and 261a may be formed only on the front surface of the first rib wall 26a, or the thickness reduction portions 260a and 261a may be formed on both front and back surfaces of the first rib wall 26a.

Although the above embodiments illustrate a case where a gap is formed between the front end of the guide wall 25a and the front wall 23a, the disclosure is not necessarily limited thereto. For example, one or both of the pair of guide walls 25a may be extended to the front side and connected to the front wall 23a, or a wall that connects the front wall 23a and the first rib wall 26a in the front-back direction may be separately provided.

Although the above embodiments illustrate a case where the gap S is formed between the top wall 21a and the second rib wall 27a, the disclosure is not necessarily limited thereto. For example, the configuration may be formed to close the gap S (connect the upper end of the second rib wall 27a to the top wall 21a), and in the case of this configuration, the partition wall 28a may be omitted, and the thickness reduction portions 260a and 261a of the first rib wall 26a may be formed by a slide core that slides in the front-back direction between the rib walls 26a and 27a.

What is claimed is:

1. A keyboard device, comprising:
a white key made of resin, with a back end side swingably supported,
wherein the white key comprises a narrow portion that constitutes a portion on the back end side of the white key, and a wide portion that is connected to a front end side of the narrow portion and has a larger dimension in a scale direction than the narrow portion,
the wide portion comprises a top wall with an upper surface serving as a key pressing surface, a pair of side walls that hang downward from both sides in the scale direction of the top wall, internal walls that are formed on a scale direction inner side with respect to the pair of side walls, and a front wall that is connected to the top wall and the side walls on a front side with respect to the internal walls,
the internal walls each comprise a thickness reduction portion that is formed at a connection portion with the top wall or the side wall, and
a thickness of the thickness reduction portion is thinner than a thickness of other portions of the internal wall.

2. The keyboard device according to claim 1, further comprising:
a white key guide that guides swinging of the white key,
wherein the wide portion comprises a pair of guide walls that are walls configured as the internal walls and face each other in the scale direction and between which the white key guide is inserted, and rib walls that extend respectively from the pair of guide walls to a scale direction outer side to be connected to the side walls, and
the guide walls each comprise the thickness reduction portion formed at the connection portion with the top wall.

3. The keyboard device according to claim 2, wherein
the thickness reduction portion of the guide wall is formed on a side surface of the guide wall facing the scale direction outer side.

4. The keyboard device according to claim 2, wherein
the rib walls each comprise the thickness reduction portion formed at the connection portion with the top wall or the side wall.

5. The keyboard device according to claim 4, wherein
the thickness reduction portion of the rib wall is formed in a visible region that becomes visible from outside in a case where an adjacent white key is pressed, while the thickness reduction portion is not formed on the rib wall positioned on a lower side with respect to the visible region.

6. The keyboard device according to claim 2, wherein
each of the rib walls comprises at least a first rib wall that connects a portion on a front end side of the guide wall to the side wall, and a second rib wall that connects the guide wall to the side wall on a back side with respect to the first rib wall, and
the guide walls are not connected to the front wall.

7. The keyboard device according to claim 6, wherein
the first rib wall comprises the thickness reduction portion formed at the connection portion with the top wall and the side wall, and
the thickness reduction portion of the first rib wall is formed in a visible region that becomes visible from outside in a case where an adjacent white key is pressed, while the thickness reduction portion is not formed on the first rib wall positioned on a lower side with respect to the visible region.

8. The keyboard device according to claim 7, wherein
the thickness reduction portion formed at a connection portion between the top wall and the first rib wall is formed on a back surface of the first rib wall.

9. The keyboard device according to claim 8, wherein
a gap is formed between the top wall and an upper end of the second rib wall, and
the gap is formed in a range where entirety of the thickness reduction portion of the first rib wall overlaps in a front-back direction.

10. The keyboard device according to claim 9, wherein
the second rib wall is formed on the lower side with respect to the visible region, and
the thickness reduction portion is not formed at a connection portion between the side wall and the second rib wall.

11. The keyboard device according to claim 2, further comprising:
a black key with a back end side swingably supported, and a black key guide that guides swinging of the black key,
wherein the black key comprises a top wall with an upper surface serving as a key pressing surface, and a pair of side walls that hang downward from both sides in the scale direction of the top wall of the black key and between which the black key guide is inserted, and
an interval between the pair of guide walls and an interval between the pair of side walls of the black key are the same.

12. The keyboard device according to claim 11, further comprising:
a guide component that is formed softer than the white key and the black key,
wherein the guide component is commonly attached to each of the white key guide and the black key guide.

13. A connection method for internal wall in a keyboard device, comprising a white key made of resin with a back end side swingably supported, wherein the white key comprises a narrow portion that constitutes a portion on the back end side of the white key, and a wide portion that is connected to a front end side of the narrow portion and has a larger dimension in a scale direction than the narrow portion, wherein the wide portion comprises a top wall with an upper surface serving as a key pressing surface, a pair of side walls that hang downward from both sides in the scale direction of the top wall, internal walls that are formed on a scale direction inner side with respect to the pair of side walls, and a front wall that is connected to the top wall and the side walls on a front side with respect to the internal walls, the connection method for internal wall comprising:
forming on each of the internal walls a thickness reduction portion that is provided at a connection portion between the internal wall and the top wall or the side wall; and
forming a thickness of the thickness reduction portion to be thinner than a thickness of other portions of the internal wall.

14. The connection method for internal wall according to claim 13, further comprising:
providing a white key guide that guides swinging of the white key,
wherein the wide portion comprises a pair of guide walls that are walls configured as the internal walls and face each other in the scale direction and between which the white key guide is inserted, and rib walls that extend respectively from the pair of guide walls to a scale direction outer side to be connected to the side walls, and
the guide walls each comprise the thickness reduction portion formed at the connection portion with the top wall.

15. The connection method for internal wall according to claim 14, wherein
the thickness reduction portion of the guide wall is formed on a side surface of the guide wall facing the scale direction outer side.

16. The connection method for internal wall according to claim 14, wherein
the rib walls each comprise the thickness reduction portion formed at the connection portion with the top wall or the side wall.

17. The connection method for internal wall according to claim 16, wherein
the thickness reduction portion of the rib wall is formed in a visible region that becomes visible from outside in a case where an adjacent white key is pressed, while the thickness reduction portion is not formed on the rib wall positioned on a lower side with respect to the visible region.

18. The connection method for internal wall according to claim 14, wherein
each of the rib walls comprises at least a first rib wall that connects a portion on a front end side of the guide wall to the side wall, and a second rib wall that connects the guide wall to the side wall on a back side with respect to the first rib wall, and
the guide walls are not connected to the front wall.

19. The connection method for internal wall according to claim 14, further comprising:
providing a black key with a back end side swingably supported, and
providing a black key guide that guides swinging of the black key,
wherein the black key comprises a top wall with an upper surface serving as a key pressing surface, and a pair of side walls that hang downward from both sides in the scale direction of the top wall of the black key and between which the black key guide is inserted, and
an interval between the pair of guide walls and an interval between the pair of side walls of the black key are the same.

20. An electronic piano, comprising:
a keyboard device, comprising:
a white key made of resin, with a back end side swingably supported,
wherein the white key comprises a narrow portion that constitutes a portion on the back end side of the white key, and a wide portion that is connected to a front end side of the narrow portion and has a larger dimension in a scale direction than the narrow portion,
the wide portion comprises a top wall with an upper surface serving as a key pressing surface, a pair of side walls that hang downward from both sides in the scale direction of the top wall, internal walls that are formed on a scale direction inner side with respect to the pair of side walls, and a front wall that is connected to the top wall and the side walls on a front side with respect to the internal walls,
the internal walls each comprise a thickness reduction portion that is formed at a connection portion with the top wall or the side wall, and
a thickness of the thickness reduction portion is thinner than a thickness of other portions of the internal wall.
